(19) United States
(12) Patent Application Publication
(10) Pub. No.: US 2023/0191268 A1
(43) Pub. Date: Jun. 22, 2023

(54) PERSONALIZED TOY FIGURE AND METHOD FOR CREATING THE TOY FIGURE FROM A DIGITAL IMAGE

(71) Applicant: Teresa Lucille ENGELHARD, Saint Kilda (AU)

(72) Inventor: Teresa Lucille ENGELHARD, Saint Kilda (AU)

(21) Appl. No.: 18/067,401

(22) Filed: Dec. 16, 2022

Related U.S. Application Data
(60) Provisional application No. 63/291,208, filed on Dec. 17, 2021.

(51) Int. Cl. A63H 9/00; A63H 3/10; A63H 3/50

(52) U.S. Cl. CPC A63H 9/00; A63H 3/10; A63H 3/50

(57) ABSTRACT

The present disclosure relates to personalized toy figures and methods of making personalized figures using a digital image.

### RELATED APPLICATIONS

The present application claims priority to U.S. Application No. 63/291,208 filed Dec. 17, 2021. This application is related to U.S. application Ser. No. 18/066,658 filed Dec. 15, 2022, which is a Continuation in Part of International Patent Application No. PCT/AU2022/051358 filed Nov. 14, 2022, which claims priority to U.S. patent application Ser. No. 17/527,884 filed Nov. 16, 2021. The entire contents of all of the aforementioned applications are incorporated herein by reference in their entireties for all purposes.

### BACKGROUND

Toy figures have been produced which use images printed on a sheet of material such as cardboard or plastic. The sheet may then be cut using a scissors or other cutting item and held upright in a base element, for instance to form a game piece. Such game pieces can be built in large quantities using volume cutting and printing equipment, and may be very difficult and expensive for home users or children to construct small quantities of game pieces or personalized figures.

### BRIEF DESCRIPTION OF THE DRAWINGS

FIGS. 1A-1D illustrate an assembly of digital images, photo sections or image sections, connectors and a base part to create a toy figurine in accordance with an embodiment.

FIG. 2 illustrates a flow diagram of a process for creating a toy figurine in accordance with an embodiment.

FIG. 3 illustrates a computing device used in the system for creation of digital images used constructing the toy figurine in accordance with an embodiment.

FIG. 4 illustrates a flow diagram of a process used by the computing device for creation of digital images used constructing the toy figurine in accordance with an embodiment.

FIGS. 5A-5C are side views of the production a photo section of the toy figurine in accordance with an embodiment.

FIGS. 6A-6D are elevated, top, side plan views of a grooved connector for holding the photo section in accordance with an embodiment.

FIG. 7A depicts an elevated views of a flat connector in accordance with an embodiment.

FIG. 7B depicts an elevated views of a grooved connector in accordance with an embodiment.

FIG. 7C depicts a side plan view of a connector for holding the photo section and engaging the connector with the base part in accordance with an embodiment.

FIG. 8 depicts a side plan view of an alternative connector for holding the photo section and engaging the connector with the base part in accordance with an embodiment

FIGS. 9A and 9B depict a top view and a perspective view of a flat connector coupled with the photo section in accordance with an embodiment.

FIG. 10 depicts a perspective view of a base part holding two flat connectors and a grooved connector engaged with a photo section in accordance with an embodiment.

FIG. 11A depicts a bottom perspective view of a flat connector with a receptacle for engaging with a stud base part in accordance with an embodiment.

FIG. 11B depicts a perspective view of a flat connector engaging with a stud base part in accordance with an embodiment.

FIGS. 12A-12D depict a top, front side, side, and top side perspective views respectively of one embodiment of a flat connector.

FIG. 13A depicts a bottom side view of a grooved connector having a cylindrical element on its base in accordance with an embodiment.

FIG. 13B depicts a perspective view of the connector shown in FIG. 13A engaging with a photo section and coupling with a magnetic block in accordance with an embodiment.

FIG. 14A depicts a perspective view of an assembled toy figurine in accordance with an embodiment.

FIG. 14B depicts the toy figurine of FIG. 14A, unassembled.

FIG. 15A depicts a toy figurine with a shoe shaped base part in accordance with an embodiment.

FIG. 15B illustrates an outline shape which may correspond to face portions of images shown in FIGS. 15D and 15E in accordance with an embodiment.

FIG. 15C depicts a toy figurine with two base parts in accordance with an embodiment.

FIG. 15D depicts a customized photo section in accordance with an embodiment.

FIG. 15E depicts a series of customized photo sections coupled with a vehicular shaped base in accordance with an embodiment.

FIG. 16A depicts a photo section template in accordance with an embodiment.

FIG. 16B depicts a customization of the photo section of FIG. 16A in accordance with an embodiment.

FIG. 17A depicts a single-groove stud connector in accordance with an embodiment.

FIG. 17B depicts a cross-groove stud connector in accordance with an embodiment.

FIG. 17C, depicts a stud connection for a grooved stud connector in accordance with an embodiment.

FIG. 18A depicts a base part with a single groove connector in accordance with an embodiment.

FIG. 18B depicts a base part with multiple groove connectors in accordance with an embodiment.

FIGS. 19A-19B depict a photo section adapted into a game piece in accordance with an embodiment.

FIGS. 20A-20B illustrate interfacing a photo section to a block toy in accordance with an embodiment.

FIG. 21 depicts a base section configured to interface a block and/or one or more photo sections to another building set in accordance with an embodiment.

### DETAILED DESCRIPTION

This disclosure is not limited to the particular systems, devices and methods described, as these may vary. The terminology used in the description is for the purpose of describing the particular versions or embodiments only and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “cell” is a reference to one or more cells and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components as well as the range of values greater than or equal to 1 component and less than or equal to 3 components. Similarly, a group having 1-5 components refers to groups having 1, 2, 3, 4, or 5 components, as well as the range of values greater than or equal to 1 component and less than or equal to 5 components, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B. and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

While the present disclosure has been illustrated by the description of exemplary embodiments thereof, and while the embodiments have been described in certain detail, the Applicant does not intend to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

In some aspects of the disclosure, toy figures can be personalized with digital photographs. The toy figures may be used as a component in a toy building set comprising: toy blocks, toy vehicles, or other toy elements to which the toy figures detachably interconnect, or any combination thereof. The assembled toy figures with a connector and base part, or base section, can include a re-attachable photo section or image section which may be personalized by the user using the systems and methods described herein. The connector and base part may be integrated into a single part, may include two or more parts, or may be eliminated. If the connector and base part are eliminated a photo section may comprise a toy figure which may lay flat on a surface. In some aspects of the disclosure, software methods can be used for enabling a user to construct a personalized figure with a section rendered with a digital image selected by the user.

A system of one or more computers and a printer can be configured to perform operations or actions by virtue of having software, firmware, hardware, or a combination of them installed on the system that in operation can cause the system to perform the actions.

One general aspect of the disclosure can include a toy figure including a photo section having a flat element rendered with a digital image, at least one base part, a connector to engage with the photo section and the at least one base part to hold the photo section in a desired position in three-dimensional space, or any combination thereof.

In another aspect a method of producing the toy figure can include printing a digital image on the top surface of image receptive material. An adhesive with a peelable paper backing can be placed on the bottom surface of the image receptive material. A digital image can be adapted by software to scale and to include a fold line. The adapted image can be imprinted on a top surface of the image receptive material and the peelable paper back can be removed from the bottom surface to expose the adhesive. The image receptive material containing the adapted digital image can be folded along a phantom (i.e., not visible) or visible fold line. The exposed adhesive on the bottom surface of the image receptive material can mutually engage on the inside (e.g., bottom surface) of the fold of the image receptive material to form a two-sided photo section. The two-sided photo section can be coupled to a connector which may attach to a base part, and the two-sided photo section can be held with the connector and base part in a desired position in three-dimensional space.

In a further aspect, a method for producing a toy figure can include the user personalizing a toy figure by selecting a digital image from a plurality of stored digital images with a processing device and/or creating with the processing device an adapted image comprising a fold line and a mirror outline image of the selected digital image. The adapted image can be sent to a printing device which can print it on a top surface of image receptive material. The adapted image is folded along a phantom fold line or a visible fold line. The bottom surface of the image receptive material when folded can form an interior, self-adhered layer. The mirror outline image and the digital image may be congruent, overlapping and/or aligned along their respective outside image boarders on opposite outer surfaces of the photo section. The photo section may be joined with a connector and/or base part.

In another aspect a photo section may comprise a complete toy figure which lies flat on a surface.

In other aspects, a connector and base part which hold a photo section may be integrally connected together as a single part.

In other aspects, a connector and base part may be designed to visually appear as an extension of the photo section, such as shoes, legs, or a body.

In other aspects, a connector and base part may be designed to visually appear as a carrier of the photo section, such as a vehicle or animal.

In a further aspect, a method for producing a photo section may include the user selecting a digital photo of a subject's face to include in the adapted image by using a digital photo editing tool, for example a loop outline cropping software tool, to digitally clip the photo of a subject's face from a larger digital photographic image.

In a further aspect, a method for creating a digital photo of a subject's face for use in the adapted image of a photo section may include using facial image recognition software to extract digital images of faces from larger digital photos that include one or many figures.

In a further aspect, in order for the name of a chosen subject to be included as a data label linked to a digital image of a chosen subject, text recognition software may be used to extract names from a larger digital photo from which the digital face of a chosen subject is extracted.

In a further aspect, a method for producing a photo section can include the use of high-resolution instant photo paper for the image receptive material to produce small faces of personalized subjects in small dimensions (e.g., including printed faces with diameters from 2 to 10 mm in diameter), and which can be of sufficient resolution for a user to recognize the subject. Examples of instant cameras and photo printers which print on image receptive material, and which may be capable of producing photo sections with recognizable faces of subjects with diameters between 2 and 10 mm include, but are not limited to, Canon SELPHY photo printers, ZINK thermal printers and FUJI Instax instant cameras.

A further aspect may include physical templates in the form of sheets which may be converted to digital images to be rendered on the photo section. Physical templates may have black and white line drawings for a child to cover. A physical template may have a rectangular outline with a desired aspect ratio. A child may create an artwork in the rectangular outline using various methods (e.g., drawing, painting, coloring). A physical template may be configured to visually pair with a connector or base part.

Example aspect ratios for a physical template can be 2:3 and 1:1 (or square). These may be common aspect ratio for digital images taken with smart phone cameras. The aspect ratio can be 2:3 for 2 inch×3 inch sticker sheets which can be receptive to images printed by thermal printers, including those sold by Canon®, HP® and Epson® which use thermally printable sticker sheets produced by Zink®. In some embodiments, the sticker sheets can be 3.5 inches×4.25 inches. Printable square sticker or label sheets may also readily be available by suppliers, including Avery®.

A physical template may be larger than the photo section on which it is printed, thereby providing an entertaining shrinking effect for a child who personalizes the physical template with a hand coloring or drawing.

An example embodiment of the present invention can be a photo section thermally printed on a 2″×3″ image receptive sheet which can depict an image of a physical template with the same aspect ratio, the physical template having been hand colored, drawn, or painted by a user.

A photo section may be a composite image formed by combining and editing more than one digital image using software methods described herein, or other software methods common in the art of image editing such as those offered by Apple®, Adobe®, Canva®, and Microsoft®. One or more of the digital images selected by a user to be digitally combined into a personalized composite image may be a digital template which frames or provides context relevant to the connector or base part which the photo section may be attached to. For example, a template may be a window frame into which one or more images with heads of particular people may be added. Further to the example, a composite image which uses a window template may be size matched to a base unit which is a toy block.

An embodiment of the present invention may be a photo section with a composite image which can include; a) an image of a physical template manually worked on by the user (e.g., with handiwork such as drawing, coloring, pasting, painting) and/or b) at least one image of the head of a person selected by the user. When such a composite image is digitally composed, printed and formed into a photo section, a user may be delighted by the combination of multiple personalization options and a size-changing effect (e.g., shrinking) due to the physical template potentially being a different size than the photo section on which it is printed.

Digital templates selected by the user to form part of a composite image may have transparent sections which may simplify the creation of a composite image using software methods. Digital templates selected by the user may be a crop tool which may apply a desired outline shape to another image selected by the user.

A photo section which utilizes a digital template may have a face image framed to suit a specific composition, connector or base part, or any combination thereof.

A physical template may have an area or part with a particular outline or shape that may be transformed into a transparency by a software method, automatically or by a user. Such a transparency may be used to frame a digital image of a particular face.

The embodiments described herein as being thermally printed on 2×3 inch sheets may not be limited in size or process. They may be different sized, printed on different sheeting, and with different printers such as desktop printers and professional printers which are common in the art.

In some aspects, the techniques described herein may relate to a toy figure that may include any combination of the following: one or more first portions, each first portion including: a first layer including an image receptive material rendered with a first digital image; a second layer including an adhesive material; and a third layer attached to the first layer by the second layer; one or more second portions, each second portion including: at least one connecting groove to engage with at least one of the one or more first portions to hold the at least one of the one or more first portions in a desired position in three-dimensional space relative to the second portion; and a three-dimensional base part, wherein the three-dimensional base part includes at least one of: shoes, feet, an animal, part of an animal, a vehicle, or a plant base, or any combination thereof.

In some aspects, the techniques described herein may relate to a toy figure, wherein the third layer may include the image receptive material rendered with a second digital image.

In some aspects, the techniques described herein may relate to a toy figure, wherein the one or more first portions can each be formed with a single sheet of the image receptive material that can be folded along a fold line to form the first layer and the third layer of the one or more first portions from the single sheet.

In some aspects, the techniques described herein may relate to a toy figure, wherein the second digital image can be a mirror image of the first digital image.

In some aspects, the techniques described herein may relate to a toy figure, wherein one of the first portions can form a one-part flat toy figure.

In some aspects, the techniques described herein may relate to a toy figure, wherein the at least one connecting groove can include a first member and a second member each having an opposing surface for engaging, through friction or tension, at least one of the one or more first portions.

In some aspects, the techniques described herein may relate to a toy figure, wherein the at least one connecting groove can include a mating section to removably engage with the three-dimensional base part.

In some aspects, the techniques described herein may relate to a toy figure, wherein the mating section can include a recess to engage a stud to removably engage the at least one connecting groove to the three-dimensional base part.

In some aspects, the techniques described herein may relate to a toy figure, wherein the mating section can include a ferromagnetic element within the at least one connecting groove, to form a connection with a magnet in a separate part.

In some aspects, the techniques described herein may relate to a toy figure, wherein the image receptive material can include at least one of: Zink stickers, Zink paper, instant film paper, thermal printer paper, plain paper, sticker paper, vinyl sticker paper, label paper, glossy paper, a laminate covering, and photo paper.

In some aspects, the techniques described herein may relate to a toy figure, wherein the digital image can include a digitized photo of a hand drawn illustration and a digital photograph of a face.

In some aspects, the techniques described herein may relate to a method of producing a toy figure that can include any of the following: imprinting a digital image on a top surface of the image receptive material, wherein the image receptive material can have an adhesive covered by a peelable paper back on a bottom surface; and wherein the image receptive material can have an area less than 64 square centimeters; removing the peelable paper back from the bottom surface to expose the adhesive; manually folding the image receptive material containing the digital image along a fold line that bisects the image receptive material into two equal parts, a first layer and a second layer; mutually engaging the exposed adhesive on the bottom surface of the first layer and the second layer to form a two-sided first portion; and pairing the first portion with a second portion including: at least one connecting groove which can be configured to engage with the first portion to hold the first portion in a desired position in three-dimensional space relative to the second portion; and a three-dimensional base part, wherein the three-dimensional base part can include at least one of: shoes, feet, an animal, an animal part, a vehicle, or a plant base that can be configured to be perceived by a user as a visual extension of the digital image.

In some aspects, the techniques described herein may relate to a method, wherein imprinting the digital image on the top surface of the image receptive material can include imprinting the digital image on the image receptive material on one side of the fold line and/or imprinting a mirror outline image of the digital image on the image receptive material on another side of the fold line such that when the image receptive material is folded along the fold line, the two images align and overlap.

In some aspects, the techniques described herein may relate to a method wherein the connecting groove can include two opposing surfaces configured to receive and/or engage the first portion between the two opposing surfaces.

In some aspects, the techniques described herein may relate to a method further including any combination of the following: scaling the digital image to a pre-determined size; creating with a processing device a mirror outline image of the digital image; and printing the digital image and the mirror outline image on separate sides of the fold line such that the outlines of the two images can align and/or overlap when the adhesive layer is exposed, and the image receptive material can be folded along the fold line to form the first portion.

In some aspects, the techniques described herein may relate to a method, which can further include: integrating a recess in the connecting groove configured to interlock via friction with a stud of diameter 4.8 mm; and

In some aspects, the techniques described herein may relate to a method wherein the digital image can include at least one of: a digitized drawing, a digitized illustration, or a digital photograph.

In some aspects, the techniques described herein may relate to a method further including: modifying the digital image based on one or more source digital images; and/or storing the digital image in response to the modification.

In some aspects, the techniques described herein may relate to a method, wherein imprinting the digital image can include printing the digital image with a printing device that includes at least one of: a Zink printer, a Zink sticker printer, an instant camera, a Zink camera, a thermal printer, a laser printer, an ink jet printer, and a dot-matrix printer.

In some aspects, the techniques described herein may relate to a part to hold a toy figure, the part including at least one of: a recess on a bottom side configured to interlock with and cover the top of a cylindrical stud of diameter 4.8 mm; and a thin, flat blade protruding lengthwise from a top side, the blade less than 75 mm long and less than 10 mm wide; wherein the bottom side of the part can have a footprint less than or equal to 9.5 mm long and 9.5 mm wide.

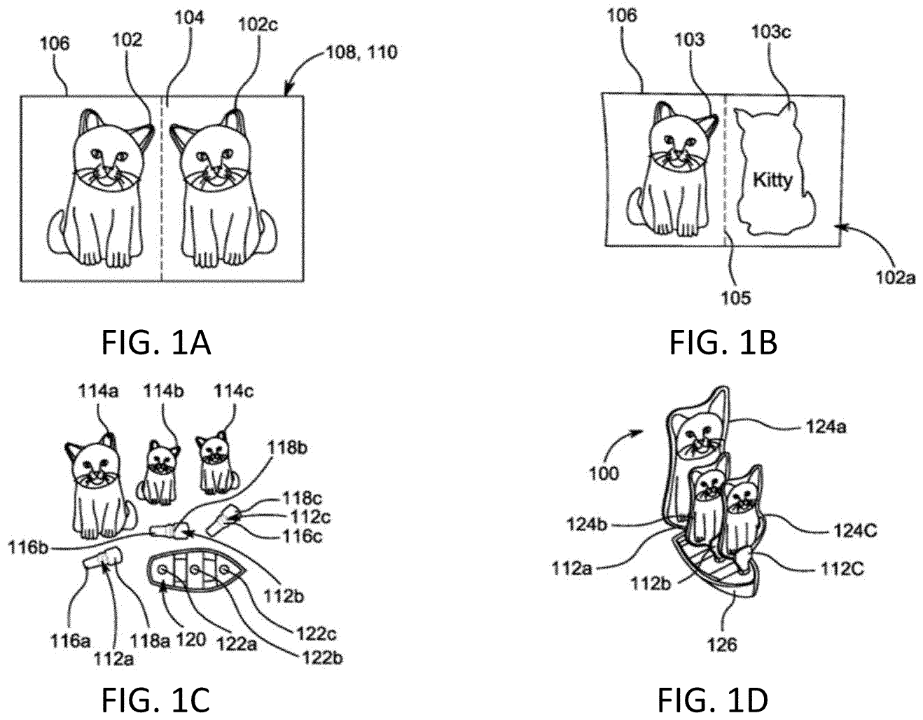

Referring to FIG. 1D there is shown assembly of a three-dimensional toy figurine 100 (also referred to herein as a toy figure) formed from three photo sections 124a, 124b, and 124c, three connectors 112a, 112b, and 112c and a base part 126.

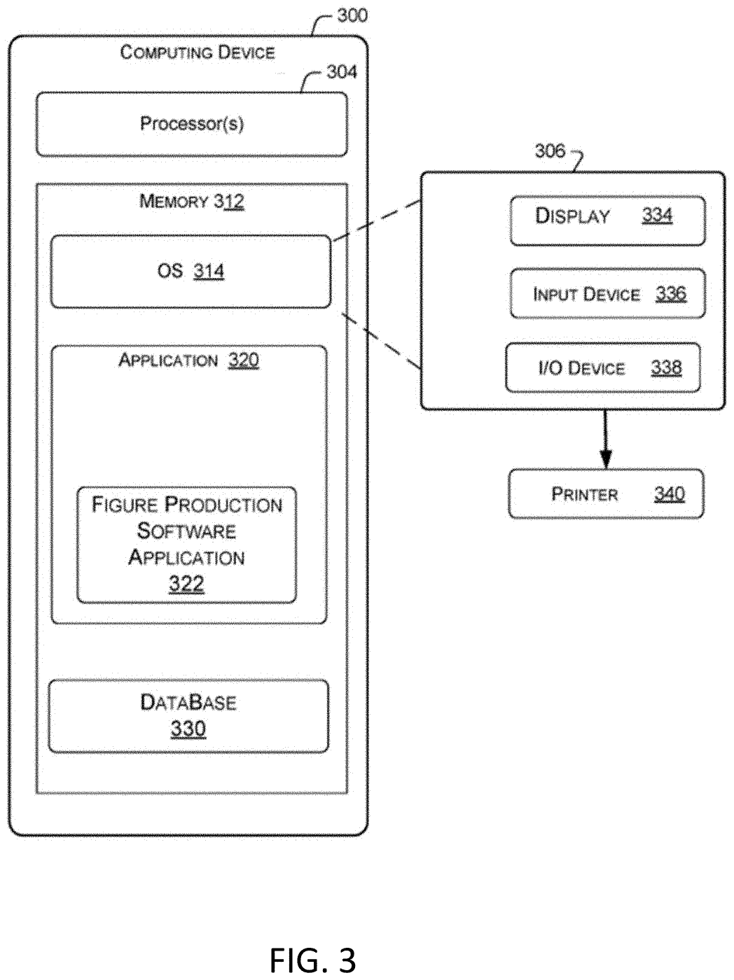

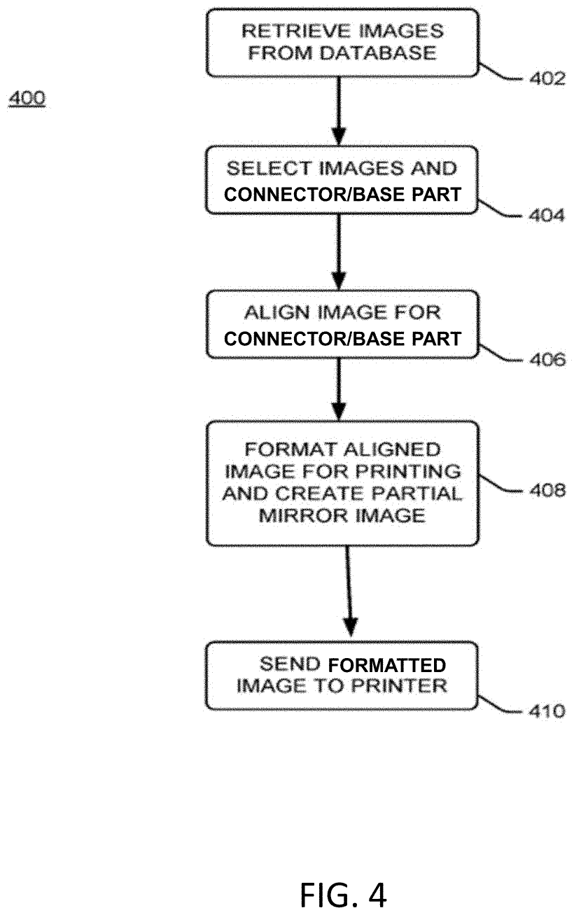

Referring to FIGS. 1A-1B, a two-dimensional digital image 102 (e.g., a photograph, drawing, or illustration) may be sent to a printer device which can print (e.g., render) the image 102 on image receptive material 106. The printer device (i.e., the printer 340 of FIG. 3) can include a Zink® printer, a Zink sticker printer, an instant camera, a Zink instant camera, a thermal printer, a laser printer, an ink jet printer, or a dot-matrix printer, or any combination thereof. The digital image 102, such as the kitten illustrated FIGS. 1A-1D can be retrieved from a library of images using process 400 as described in FIG. 4. The process 400 as described herein may size the image 102 and create a mirror copy image 102c of the image 102. The process may print image 102 and image 102c (and/or smaller images 102a which may include image 103 and image 103c) with or without fold line 104 (also referred to herein as a mirror line) and with or without fold lines 105 for smaller images on the image receptive material 106 as shown in FIGS. 1A-1B.

Alternately the images 102, 102c, 103 and 103c may be printed on image receptive material 106 without the fold line but can be equally spaced from a non-visible line that bisects image receptive material 106. The fold line may be placed at a middle of sheet lengthwise or widthwise so that opposite corners of the sheet can align when the sheet is folded on the fold line.

The image receptive material 106 can have an adhesive backing 108 with a removable film protective cover 110 extending over the adhesive backing. Alternately, adhesive may be physically applied by a user or device to the image receptive material 106.

Referring to FIG. 1A, a removable film protective cover 110 on the image receptive material 106 can be removed and the image 102 and image 102c can be folded along optional fold line 104. Referring to FIGS. 1A and 1C, the adhesive backing 108 on the back surface of image 102 and image 102c can be connected to form photo section 114a (and/or photo sections 114b and 114c). The photo section 114a (and/or photo section 114b and photo section 114c) may then be trimmed along its outside edge to remove any margin. The trimmed photo sections 114a-c may be engaged with one end 116a, 116b, and 116c of connectors 112a, 112b, and 112c respectively. The other end 118a, 118b, and 118c of connectors 112a, 112b or 112c respectively may be inserted into one of receptacle 122a, 122b, and 122c within base part 120 to form a three-dimensional toy figurine 100 (See FIG. 1D). At least one of the connectors 122a-122c may engage with at least one of the photo sections 114a-c and at least one base part 120 to hold the photo section 114a-c in a desired position in three-dimensional space relative to base part 120.

The process for producing a toy figure may include selecting a template. The template may be a digital template or a physical template. A digital template may be selected from a series of digital image files stored either locally or remotely (e.g., a website). A physical template may be selected from a collection of physical templates (e.g., a booklet). The digital template may be printed into a physical template and manipulated as described herein. A physical template may include a line drawing. A physical template may include a marking or fiducial (e.g., a QR or bar code) which may identify the template and/or provide location information associated with the template to a computer system, when the template is captured via a camera or scanner. A physical template captured by a camera or scanner may become a digital template and manipulated as described herein.

The template may be customized by a user. A physical template may be customized using ink, pencils, crayon, paint, glue, glued/adhered on elements (e.g., other images, glitter, stickers, etc.). A digital template may be customized via software configured for digital image manipulation (e.g., Canva® or Adobe Illustrator®).

A digital template may include one or more regions configured for inserting a photograph. The one or more regions may be configured as a transparent region. The photograph may be digital placed in reference to the digital template with only the portions overlapping the transparent region being visible. Alternatively, the digital template may be used in conjunction with a digital photography application. For example, a user may be prompted to take a photo using a mobile phone, tablet, or computer camera, where the digital template overlays the photo such that only the transparent region depicts the camera's view through the digital template. On taking the photo, the combined view of the camera and digital template may be merged into a single image. Multiple photos may be merged with multiple regions of a template in a similar manner.

A digital template may include one or more outlined or cropped regions. For example, a digital template may be configured such that any customization outside an outer border can be cropped from the image. A specific crop outline may include cropping the specific outline of, for example, a face, a head, body, or thing which separates the head, body, or thing from the background of an image. A crop outline template may be used to adapt a source image to have a predetermined outline shape.

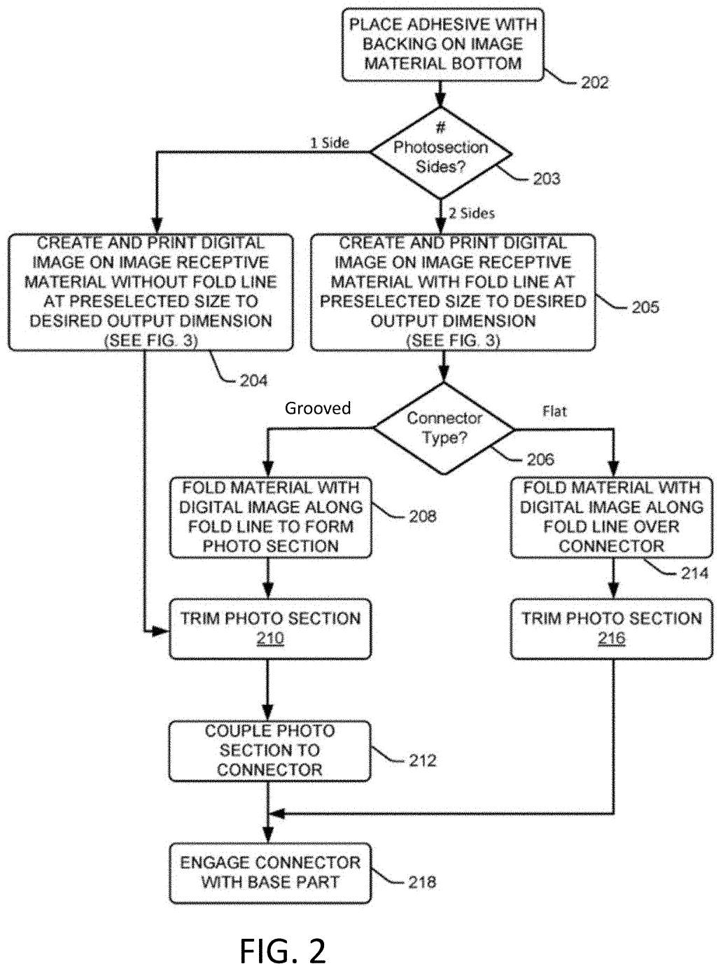

FIG. 2 illustrates a logical flow diagram, which represents a sequence of operations that can be implemented to construct the toy figurine 100 in accordance with an embodiment.

In block 202, an adhesive can be applied to the one side of an image receptive material (e.g., plain paper, cardboard, construction paper, matt paper, a Zink sticker, sticker paper, vinyl sticker paper, label paper, glossy paper, a laminate covering, or photo paper, or any combination thereof) and a removable backing layer may then be applied to cover the adhesive. The image receptive material may be receptive to one or more inputs that aid in the creation of the image such as heat (e.g., Zink) or ink. The image receptive material may include film (e.g., INSTAX®, POLAROID® or SELPHY® material) that can be photo receptive.

In block 203, a determination can be made on how many sides of the image receptive material the digital image will be imprinted. In response to a determination that the digital image is to be imprinted on one side, in block 204, the system can create and print the digital image on the image receptive material at a preselected size (e.g., by the software based on a known template size or by the user) having a desired output dimension without a fold line. Once the one-sided digital image is printed, the printed image may be trimmed in block 210 to form a photo section.

If the digital image is to be imprinted on two sides of the toy figure, in block 205, the system can create and print the digital image and a second digital image. The second image may be a mirror image of the original digital image or a new digital image that is not a mirror copy (e.g., a blank image, a default textual, graphical, photographical, or illustrative pattern, a unique digital image based on the same or a mirror template of the original digital image, or a unique digital image cropped to a mirrored template of the original digital image, or any combination thereof) on the image receptive material. In some embodiments, a user may select a size for the digital image with a desired output dimension and a fold line to create the photo section. In further embodiments, the desired output dimensions may be selected from one or more predetermined dimensions. The image and copy may be separated when printed by a uniformly colored (e.g., white) or textured space (e.g., a pattern of stars) with the fold line floating in the uniform space. The image can be printed on the top surface of a first section of the image receptive material and the second image can be printed on a second section of the image receptive material. In some embodiments the fold may be a distance from the images to be able to trim the fold (e.g., with a flat connector the fold may be trimmed off).

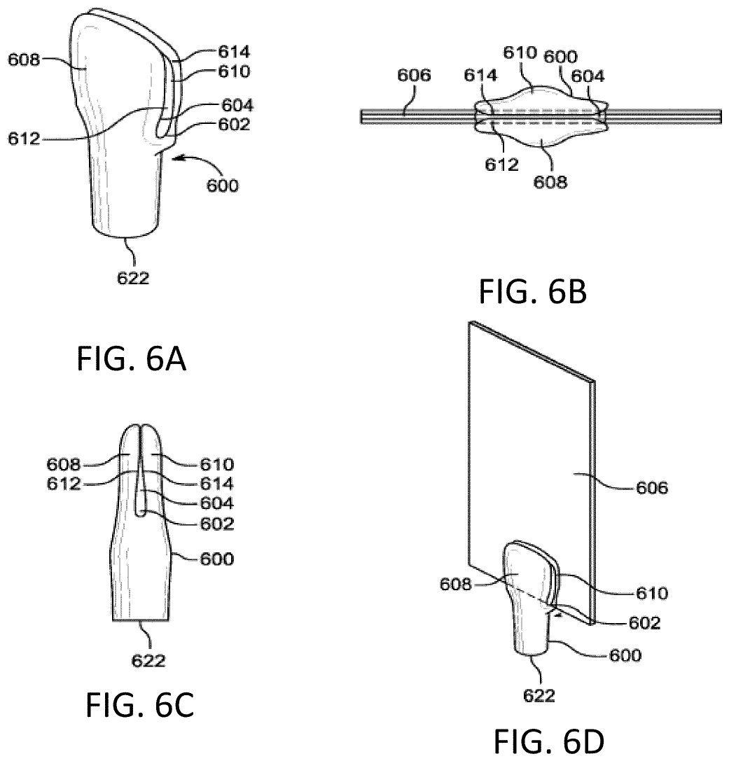

In block 206, a determination can be made as to the type of connector. An example of a connector which has a groove comprising two opposing flat surfaces to engage a photo section (referred to herein as a grooved section or grooved connector) is shown in FIGS. 6A-D. FIGS. 6B and 6D show a grooved section gripping the photo section.

If a determination can be made that the connector is grooved, in block 208, the adhesive back, if present, can be removed. With the adhesive exposed, the digital image may then be folded along the fold line to mutually engage a bottom surface of the image receptive material below the first image with the bottom surface of the image receptive material located below the second image the digital image. This folding can result in the formation of a photo section flat element with the respective outside image boarders of the digital images aligning. In some embodiments, the photo section flat element may be, for example, trimmed (e.g., with scissors) or perforated and punched out along the outside boarder of the images in block 210.

In block 212 the photo section may be coupled to the grooved section.

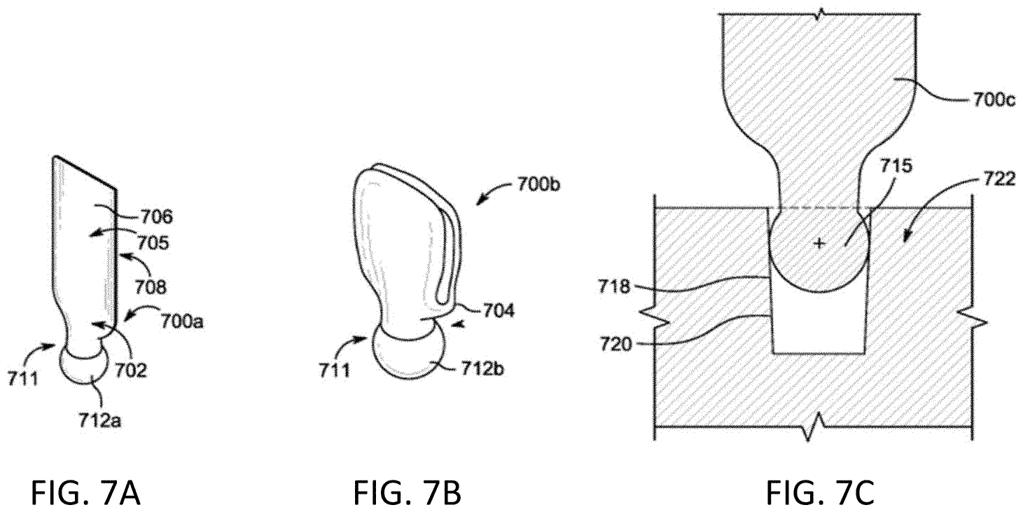

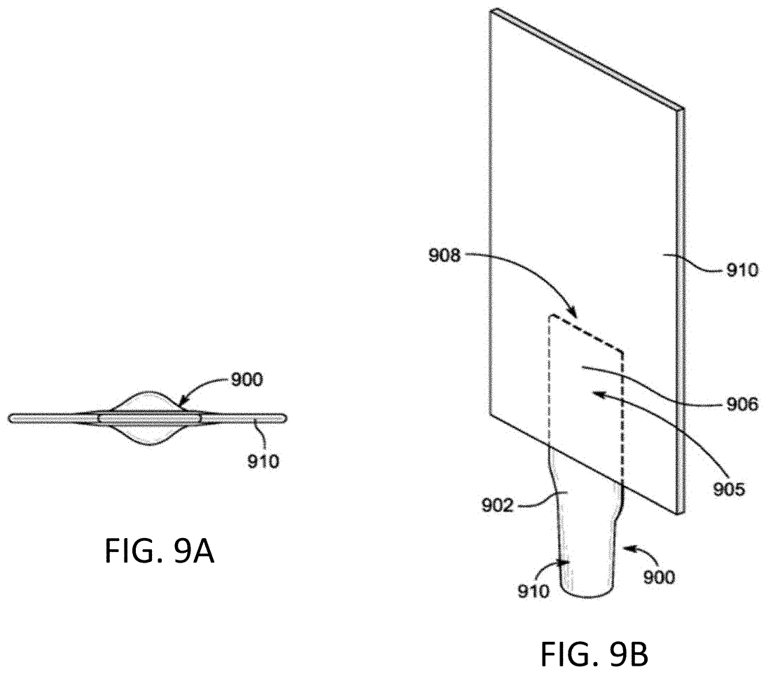

If a determination can be made that the connector includes a double-sided flat surface (also referred to herein as a flat connector as shown in FIGS. 7A and 9A-B), in block 214 the adhesive back can be removed, the bottom surface adhered to the flat surface and the digital image can be folded in half over the flat surface. The digital image may cover the flat element to form a photo section flat element which includes a flat connector adhered between its two sides (See FIGS. 9A-9B) and the photo section can be trimmed in block 216.

In block 218 the connector may be engaged with a base part to form the three-dimensional toy figure.

Portions of the processes described herein may be performed by the manufacturer or end user. For example, in some embodiments, the manufacturer may provide a template, either physically or digitally, to the user, which the user can customize and can return to the manufacturer for printing. A completed image section and base section may then be provided to the user. In other embodiments, the user may use software to locally produce portions of the toy figurine. For example, the user may print the images and form the image section and/or use a 3D printer to produce the base section.

### Example Computing Device Architecture

In FIG. 3 there are illustrated selected modules in a computing device 300 that may be used to create, alter, store, or edit one or more of the of digital images. The computing device may include a digital camera, a scanner, a general-purpose computer, a tablet, a smart phone, and a personal device assistant (PDA). The computing device may further include cloud processing. The computing device 300 can include a processing device 304, and/or memory 312. Processing device 304 (also referred to as a processor) may include a microprocessor, microcontroller or any such device for accessing memory 312, and device hardware 306 (which may include display device 334, input device 336, and I/O device 338). Processing device 304 can have processing capabilities and memory suitable to store and execute computer-executable instructions. In one example, processing device 304 can include one or more processors. The one or more processors may be located in multiple servers or systems.

Processing device 304 can execute instructions stored in memory 312, and in response thereto, can process signals from hardware 306. Hardware 306 may include I/O device 338 having network and communication circuitry for communicating with a network or a printer controller for communicating with printer 340. Input device 336 can receive inputs from a user of the computing device through one or more input devices including any combination of: a keyboard, mouse, track pad, microphone, audio input device, video input device, or touch screen display. Display device 334 may include an LED (Light emitting diode), LCD (Liquid crystal display), CRT (cathode ray tube) or any type of display device.

Memory 312 may include volatile and non-volatile memory, removable and non-removable media implemented in any method or technology for storage of information, such as computer-readable instructions, data structures, program modules or other data. Such memory 312 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium (including a non-transitory computer readable storage medium) which can be used to store the desired information, and which can be accessed by a computer system. The storage may be local or cloud-based.

Modules stored in memory 312 of the computing device 300 may include an operating system 314 having an I/O controller, a database 330, and application 320. The operating system 314 may be used by applications 320 to operate the computing device 300. I/O device 338 (also referred to as a controller) may provide drivers for computing device 300 to communicate with hardware 306 or printer 340. Database 330 may include digitized drawings, digitized illustrations, digital photographs, prestored images, prestored material (paper) sizes, alpha numeric text, and other parameters such as personal computing device operating parameters and configurations.

FIG. 4 illustrates a collection of blocks in a logical flow diagram, which represent a sequence of operations that can be implemented in hardware, software, and a combination thereof. In the context of software, the blocks can represent computer-executable instructions that, when executed by one or more processors, perform the recited operations. Generally, computer-executable instructions can include any combination of routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

The process 400 may performed by processing device 304 when executing the software instructions in application 320, and specifically the Figure Production Software Application 322 shown.

In the process 400, the computing device 300 (FIG. 3) in block 402 can request retrieval of digitized drawings, digitized illustrations, digital photographs, graphic images, other drawings and/or other illustrations (collectively referred to herein as images) stored in database 330. The database 330 may be located on the computing device 300 or may be accessible via a network, such as the internet.

In block 404, the user may select the images from the database 330, the connector type that will hold the printed image, and the final size of the image. Alternatively, one or more of these inputs may be predetermined. For example, the printer may be configured to print a predetermined size. In another example, choosing a specific connector type and/or base part may automatically provide an optimal image size.

In block 406, the image can be formatted, aligned, and sized for the selected connector and/or base part.

In block 408, the formatted image can be aligned for printing, and at least a partial mirror of the selected digital image can be created. The partial mirror image can be created with an outside boarder such that when printed the outside boarder of the formatted image can align with the outside boarder of the partial mirror image. In some embodiments, a different image may be substituted for the mirror image, that may be formatted so the boarders at of the formatted imaged and the substituted image align. In some embodiments the partial mirror image may be a full mirror image.

In block 410 the aligned image and the mirror image (or the substitute image) along with an optional fold line that bisects the two images can be sent to a printer (e.g., printer 340) to be printed on a top surface of the image receptive material. The printer can print the digital image on a top surface of a first section of an image receptive material and can print the mirror image on a top surface of a second section of the image receptive material, and optionally can print a fold line bisecting the two images. In some embodiments, the fold line may be prestressed and/or perforated to guide and/or ease the folding process.

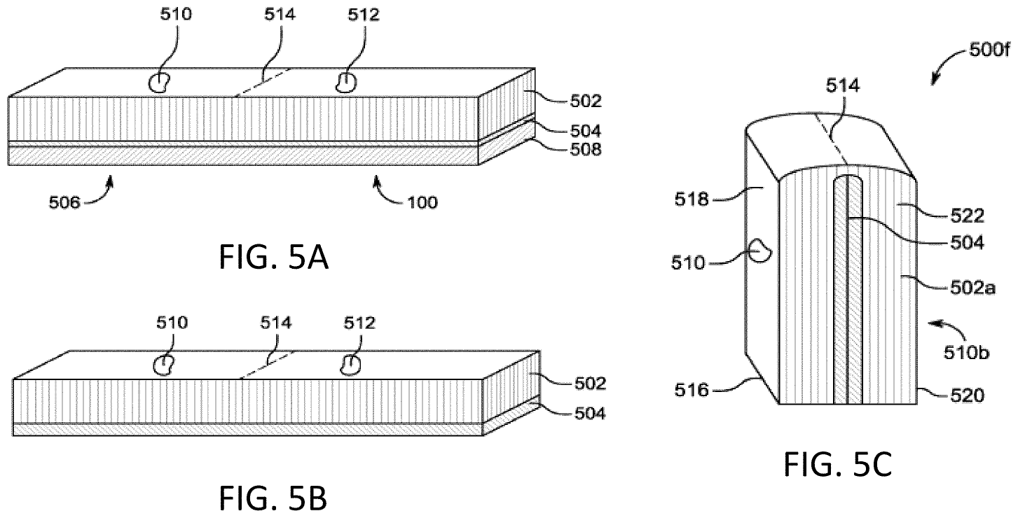

In FIG. 5A-5C there is shown a photo section that includes image receptive material 502 with layer of adhesive 504 on a bottom side 506 of the image receptive material 502, and a peelable paper backing 508 covering the adhesive 504. Imprinted on the top surface of the image receptive material 502 can be a formatted digital image 510 and a mirror or alternative image 512, with optional fold line 514 bisecting the digital image 510 and alternative image 512.

In FIG. 5B, the photo section of FIG. 5A is shown with the peelable paper backing 508 removed.

Referring to FIG. 5C, the photo section 500f is shown formed from photo section of FIG. 5B by folding a single sheet of the image receptive material 502 along fold line 514. As a result of the folding, a flat element photo section 500f can be formed with a first layer 516 having the formatted digital image 510 on a top surface 518 of the first layer 516. Photo section 500f can have a second layer of adhesive 504 and a third layer 522 of image receptive material 502a with the alternative image 510b (e.g., a mirror image of formatted digital image 510) imprinted on a top surface 520 of the third layer 522. In some embodiments, the outline of the alternative image 512 and the formatted digital image 510 may be congruent, overlapping and/or aligned along their respective outside image boarders on opposite outer surfaces of the photo section 500f.

Referring to FIGS. 6A-6D, there is shown a connector 600 having a grooved member 602 that forms a groove opening 604 to receive and engages with the photo section 606. The grooved member 602 at one end can include both a first member 608 and a second member 610 each having a flat opposing surface 612 and 614 respectively for releasably engaging and supporting the photo section 606 formed as a flat element. In some embodiments, grooved member 602 can be constructed from a flexible material to enable first member 608 and second member 610 to flex toward each other and away from each other to support photo section 606. Connector 600 at its other (bottom) end 622 may be tapered, be formed a partial sphere, or have a flat bottom surface for either holding a magnet or forming a receptacle as described herein.

Referring to FIG. 7A-7B, there is shown a connector 700a that can be formed as a protruding flat section 702 (in FIG. 7A) and connector 700b formed into a grooved member 704 (in FIG. 7B).

Referring to FIG. 7A, protruding flat section 702 can have an upper portion 705 forming a flat surface 706 on one side and another flat surface 708 on the other side. The photo section, as previously described, can engage with the protruding flat section 702 by being folded around the flat surface 706 and flat surface 708 as shown in more detail in FIGS. 9A and 9B. Specifically, the protruding flat section 702 of the connector can be sandwiched between the adhesive layers attached to the first and third layers of the image receptive material when the first and third layers of image receptive material are folded together to form the photo section of the toy figure.

Referring to FIG. 7B, connector 700b on its upper portion can form the grooved member 704 (grooved member 602 in FIGS. 6A, 6C and 6D).

Referring to FIGS. 7A-7B, a bottom portion 711 (also referred to as a bottom tip) of connector 700a and connector 700b can form a partial sphere 712a and 712b.

Referring to FIGS. 7A-C, the bottom tip of connector 700a or 700b (connector 700c of FIG. 7C) can have a partial spherical shape 715 and can mate with a tapered cylindrical hole 718 formed by wall 720 within a base part 722. When connectors 700a, 700b, or 700c bottom tip engages with wall 720, connectors 700a-c may be held in place at a vertical orientation, may be rotated and/or may be pivoted to engage with the base part 722 at an angle (e.g., 45 degrees).

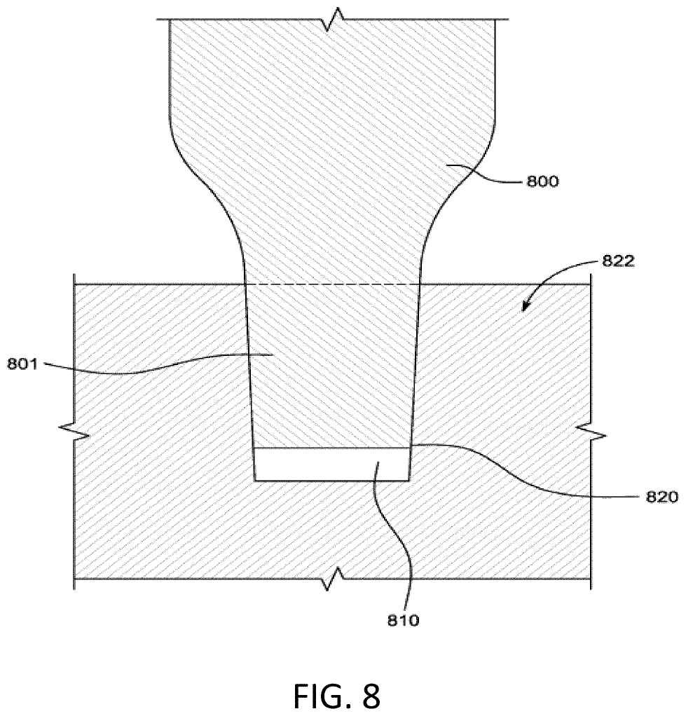

Referring to FIG. 8, there is shown a connector 800 having a bottom tip 801 of connector 800 (e.g., connector 700a or 700b) with a cylindrical shape to create a receptacle. The bottom tip 801 can mate with a tapered cylindrical hole 810 formed by wall 820 within a base part 822. When base part 822 of connector 800 engages with wall 820, connector 800 may be held in place at a desired vertical orientation within base part.

Referring to FIGS. 9A and 9B, there is shown a connector 900 having flat section 902 with an upper portion 905 forming a flat surface 906 on one side and another flat surface 908 of flat section 902 other side. Photo section 910 can engage with flat section 902 by being folded around and adhered to flat surfaces 906 and 908. A bottom portion of connector 900 can mate with a base part as previously described.

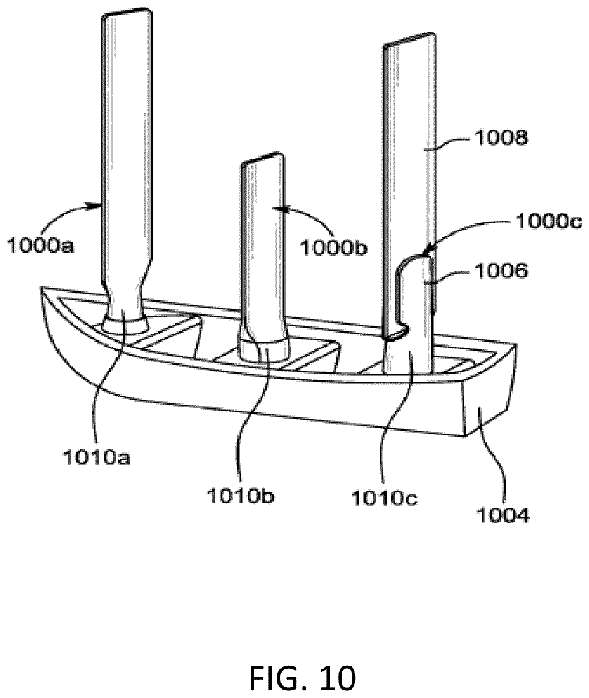

Referring to FIG. 10, there is shown three connectors 1000a-1000c engaging with a cylindrically shaped receptacles 1002a-c respectively within base part 1004. Connector 1000a and connector 1000b can have an upper portion forming a flat section, and connector 1000c can have an upper portion forming a grooved member 1006 that engages with photo section 1008. The bottom tips 1010a and 1010c of connector 1000a and connector 1000c can be spherically shaped. The bottom tip 1010b of connector 1000b can be cylindrically shaped.

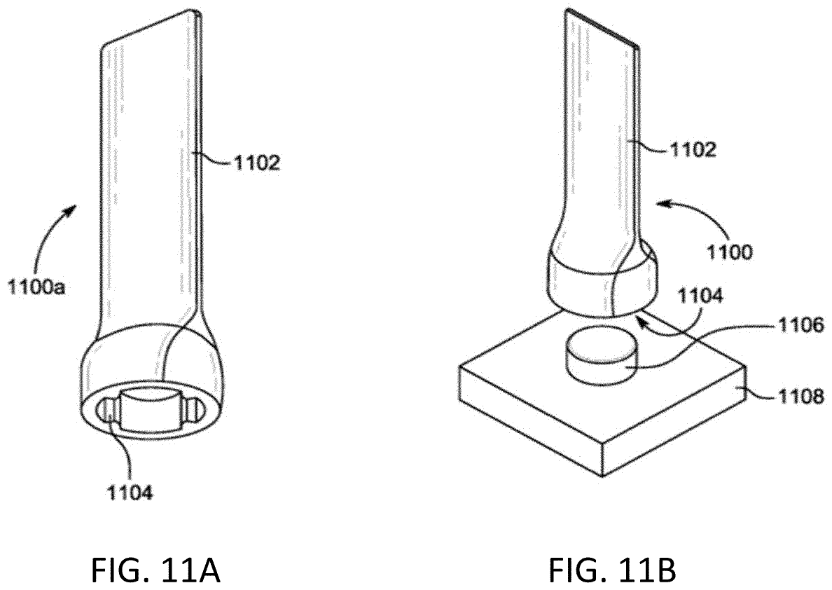

Referring to FIGS. 11A and 11B, there is shown a connector 1100a with a formed flat section 1102 (as previously described) having a bottom portion forming an integral receptor 1104. In another embodiment, a connector formed with a grooved member (not shown), may have a bottom portion forming a receptor.

Referring to FIG. 11B, receptor 1104 of flat connector 1100 may interlock with a protrusion 1106 (also referred to as a convex element, or a stud) of a base part 1108. One exemplary base part 1108 may be a LEGO® style block. Although FIG. 11B shows the receptor 1104 being disposed on the connector 1100 and the protrusion 1106 being disposed on the base part 1108, in an alternate embodiment the receptor may be disposed on the base part, and a protrusion, convex element or stud may be disposed on the connector.

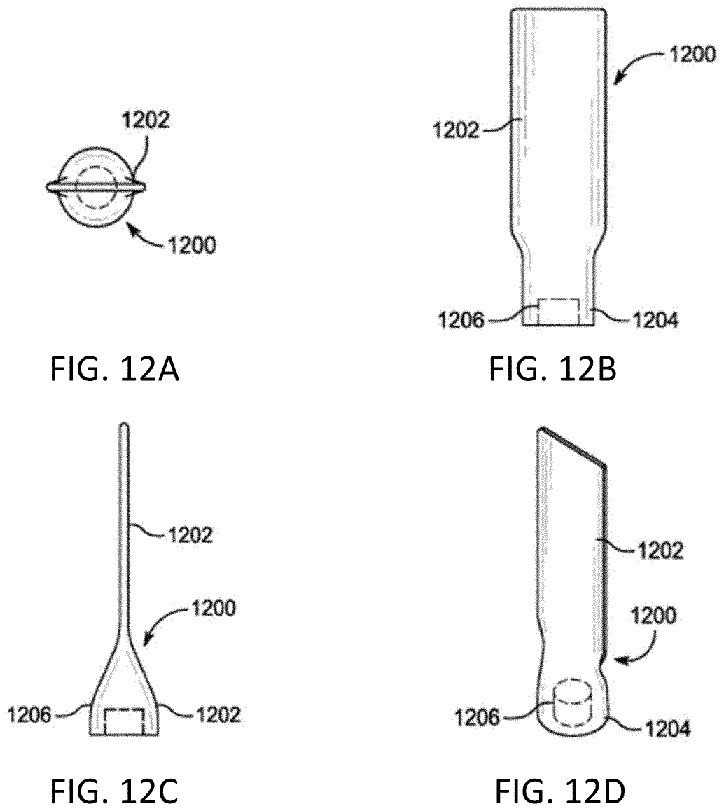

Referring to FIGS. 12A-D, there is shown alternate views of a connector 1200 forming a flat section 1202 (as previously described). A bottom tip 1204 of connector 1200 may be carved out to from a cylindrically shape 1206 to either receive a cylindrical magnet, a magnetic metal cylinder or to engage with a protruding section of a base part.

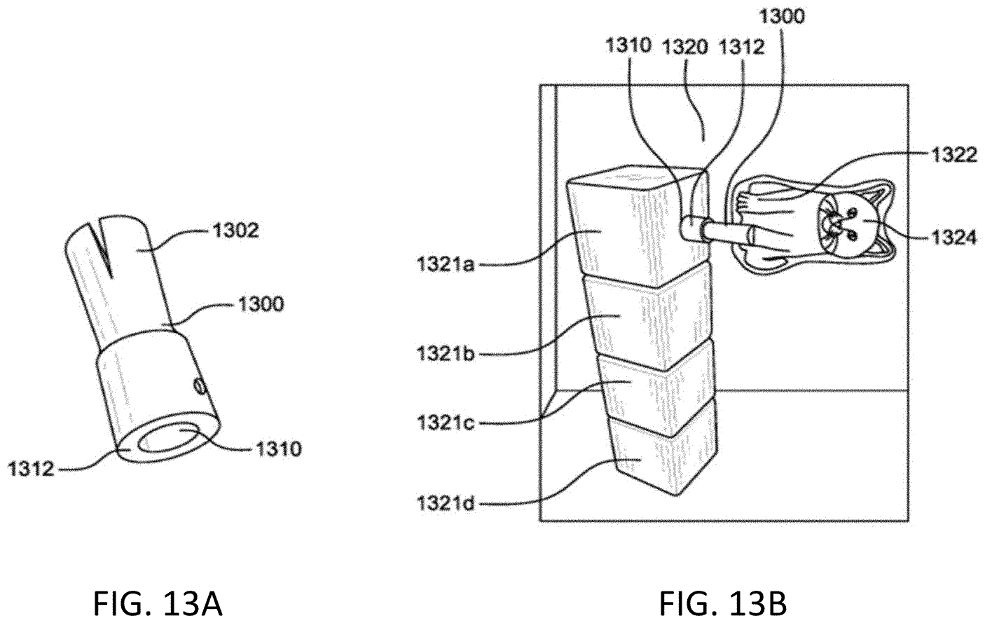

Referring to FIG. 13A, there is shown a connector 1300 having a grooved member 1302 formed with opposing flat surfaces (as previously described) for engaging with a photo section. A magnet 1310 or a cylinder of ferromagnetic metal may be inserted into a bottom tip 1312 of connector 1300.

Referring to FIG. 13B, there are shown one or more base parts 1320 formed of cubes 1321a, 1321b, 1321c and 1321d. Cubes 1321a, 1321b, 1321c and 1321d may internally contain either magnets or a metal object (not shown). A flat element 1322 of an image section 1324 may engage with the connector 1300. Magnet 1310 on bottom tip 1312 of connector 1300 may be positioned to engage with the internal magnet or metal object on at least one of the cubes 1321a. Such engagement between the base part and the bottom tip 1312 may results in the connector 1300 supporting photo section in a vertical or horizontal orientation.

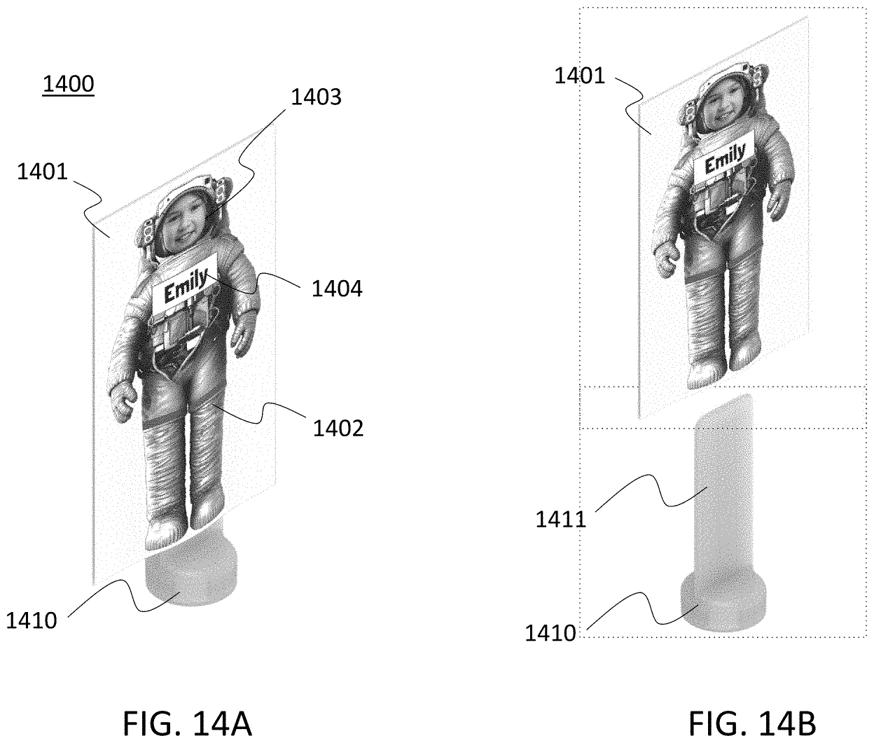

Referring to FIG. 14A, an assembled toy figurine 1400 is depicted in accordance with an embodiment. The toy figurine 1400, as generated by the processes described herein, may include a photo or image section 1401 and a base section 1410. The image section 1401 may include one or more physical or digital customizations by the user. For example, a main portion 1402 of the image section 1401 may be customized through coloring. A region 1404 may be modified to include digital information provided by the user. Another region 1403 may be modified to include a photograph of the user. As illustrated in FIG. 14B, the base section 1410 may include a connector 1411 such as the flat connector depicted in FIGS. 12A-D.

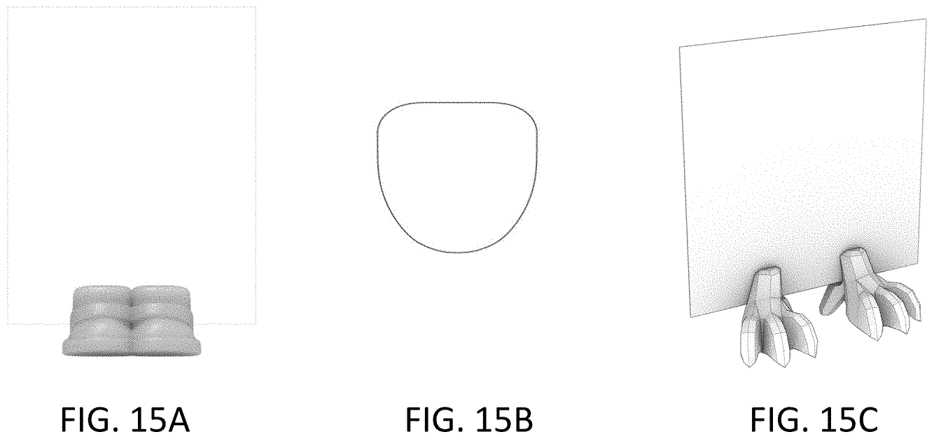

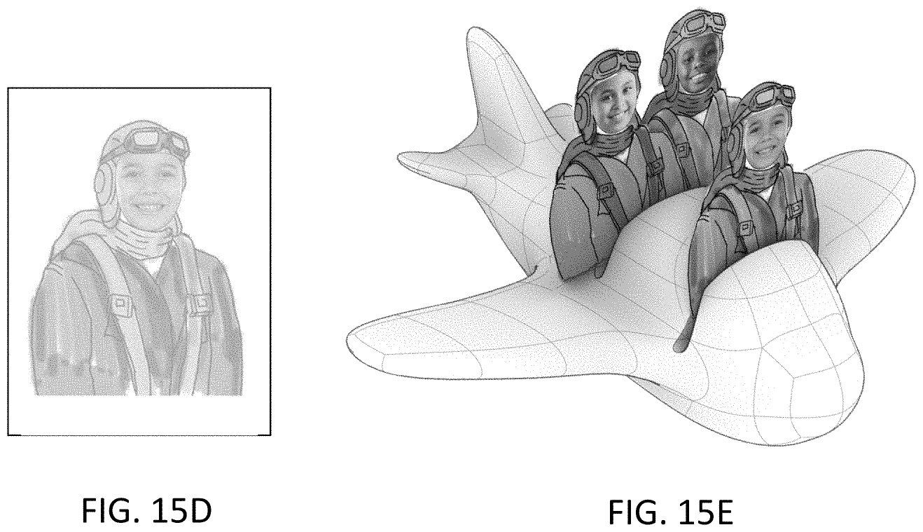

The base sections have been disclosed herein with respect to their utility (e.g., a solid base or connection to another toy set). In some embodiments, the base sections may be adapted to have the shape of known objects. For example, FIG. 15A depicts a toy figurine with a shoe shaped base. FIG. 15B illustrates an outline shape which may added to a template to apply to a face of a toy figurine, a. The toy figurine may include an image section which may depict a body image that when coupled with the shoe shaped base appears to be wearing the shoes. FIG. 15C depicts another example base, shaped like a pair of animal feet. In this example, each foot may be a separate element individually coupled to the image section.

Referring to FIG. 15D a customized image section is depicted in accordance with an embodiment. In the example, a user's face may be added to a template of a pilot which applies an outline shape shown in FIG. 15B. In FIG. 15E, multiple image sections may be coupled to a single base representing a vehicle (e.g., a plane). As depicted an integral connecting groove may be implemented to allow for multiple image sections to be coupled via a single groove. The connecting groove may allow the image section to be translated along the groove (i.e., moved along the seat represented by the groove).

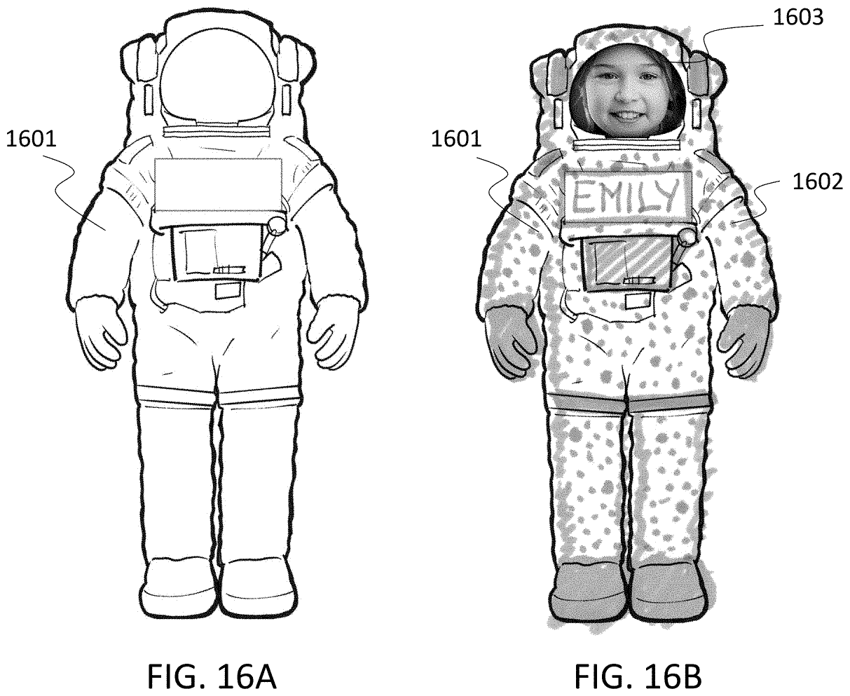

Referring to FIG. 16A, an image section template 1601 is depicted in accordance with an embodiment. FIG. 16B depicts an example customization of the image section of FIG. 16A in accordance with an embodiment. The customization may include one or more manually modified regions 1602 1603 by the user. For example, a portion of the regions may be colored 1602 by the user. In another example, a portion of the regions may include transparency to merge a digital photo 1603 with the image. In merging the digital photo 1603 with the template 1601, one or more effects may be automatically applied to transition between the photo 1603 and the template 1601. For example, a fade or gradient effect may be applied between the edges of the photo 1603 and the template 1603. The user may perform one or more customizations outside the outer border of the template 1601. Prior to printing, the system may be configured to crop customizations outside the border.

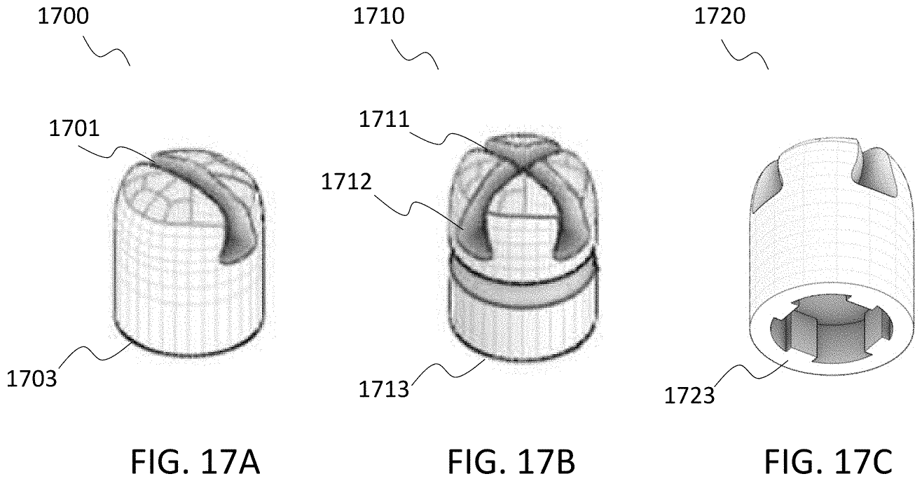

Referring to FIG. 17A a single-groove stud connector 1700 is depicted in accordance with an embodiment. The connector 1700 may include a groove 1701 for coupling an image section and a base 1703 for interfacing to another building set. FIG. 17B depicts an alternative connector 1710 in accordance with an embodiment. The connector 1710 may include two crossed grooves 1711/1712 for coupling one or more image sections and a base 1713 for interfacing to another building set. In some embodiments, the cross may form a 90° angle between the two grooves, but other angles may also be useful. As illustrated in FIG. 17C, in some embodiments, the base may include a recess for interfacing to a stud in building sets like LEGO. Alternatively, the base can include other interfacing elements such as studs, ferromagnetic element, clips, or rods (e.g., for KINECT®). In further embodiments, the base may include multiple interface elements. For example, the base may include a 2-by-2 grid of recesses or studs.

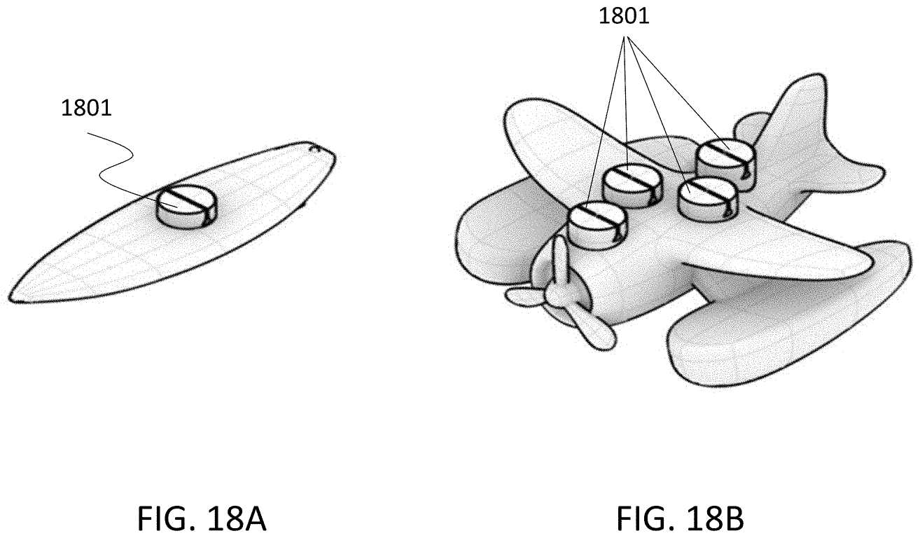

Referring to FIG. 18A, a base section with a groove connector 1801 is depicted in accordance with an embodiment. The groove connector 1801 may be raised in relation to the base section to also function as a stud connector in another building set (e.g., LEGO or LEGO DUPLO®). As a result, a user may choose to interface either an image section, a connector with a stud recess such as those shown in FIG. 11 or FIG. 17 A-C, or a unit of the other build set (e.g., a LEGO minifigure) to the base. In some embodiments, the stud connector may have a diameter of 4.8 mm. In some embodiments, the linear groove may have a width ranging from 0.25 mm to 1.0 mm bisecting the stud. FIG. 18B depicts a base section with multiple grooved stud connectors 1801 in accordance with an embodiment. In some embodiments, the multiple grooved stud connectors 1801 may be spaced in an arrangement compliant with the spacing of connectors in the other building set. In alternative embodiments, the multiple grooved stud connectors 1801 may be spaced to improve some other aspect of playability for the figurine. In some embodiments, a linear groove or set of grooves may be rotated relative to their respective studs or base part to improve some aspects of playability for the figurine.

In some embodiments, base sections may be shaped as shoes, feet, an animal, part of an animal, a vehicle, or a plant base (e.g., a tree trunk or part of a flower stem), or any combination thereof. In other embodiments, the base sections may be shaped as architectural elements.

Although the examples provided herein depict the base as the bottom element of the toy figurine, other configurations are presented. In some embodiments, the base sections may be configured to hang from structural elements in other building sets. For example, the base section may be shaped as a monkey's tail or a hand allowing the image section to hang from a rod or string.

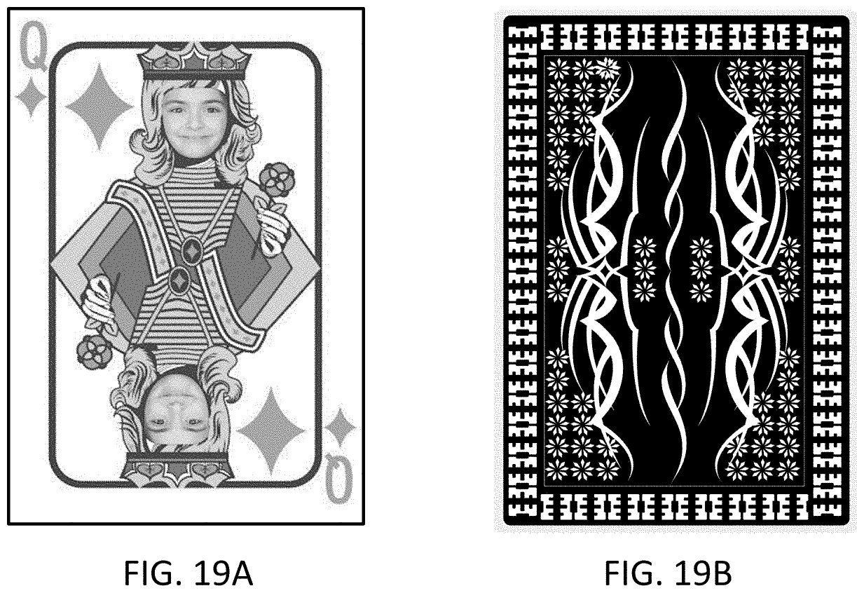

Referring to FIGS. 19A-19B, an image section is adapted to form a game piece in accordance with an embodiment. In the example, the image section template may be used to generate a playing card featuring the user's face. Other game pieces, such as tokens, for all types of board and tabletop games, may be created using the image and base sections described herein.

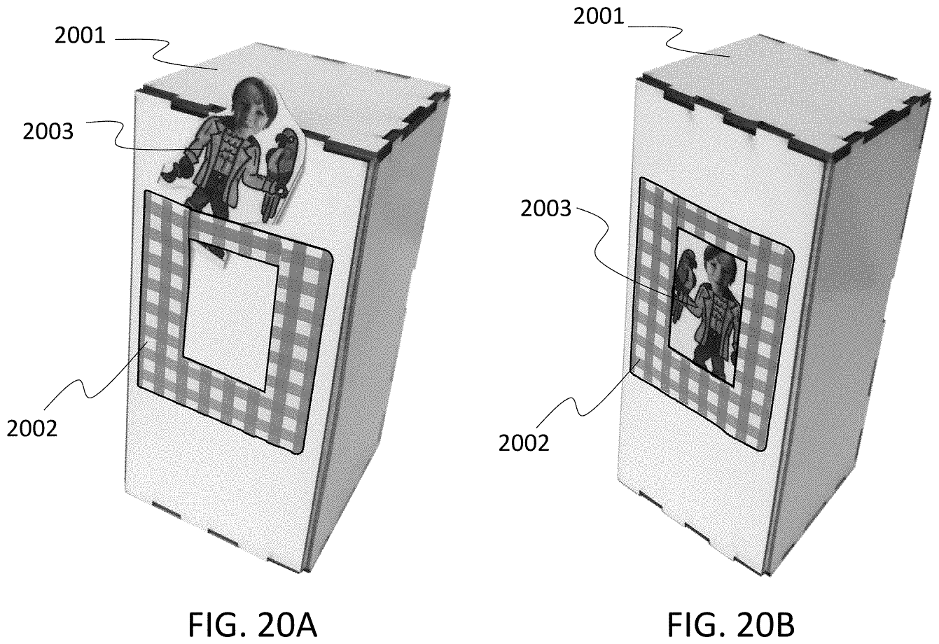

Referring to FIGS. 20A-20B, interfacing an image section 2003 to a building unit 2001 is illustrated in accordance with an embodiment. The building unit 2001 may be a block as presented in U.S. patent application Ser. No. 18/066,658, filed Dec. 15, 2022, which is incorporated by reference herein. A ferromagnetic connector 2002 may couple the image section 2003 to the building unit 2001. The building unit 2001 may include one or more magnets. Alternatively, another connector may be placed inside the building unit 2001 to magnetically couple across the wall of the building unit 2001. The connector 2002 may include one or more at least partially transparent or cutout portions allowing the user to view the image section 2003 through the connector 2002. Alternatively, the connector 2002 may be adhered to the building unit with some portion of the connector 2002 unadhered, the unadhered portion creating a slot between the connector 2002 and the building unit 2001 through which the image section 2003 may slide (as shown in FIG. 20A) for insertion and removal of the image section 2003.

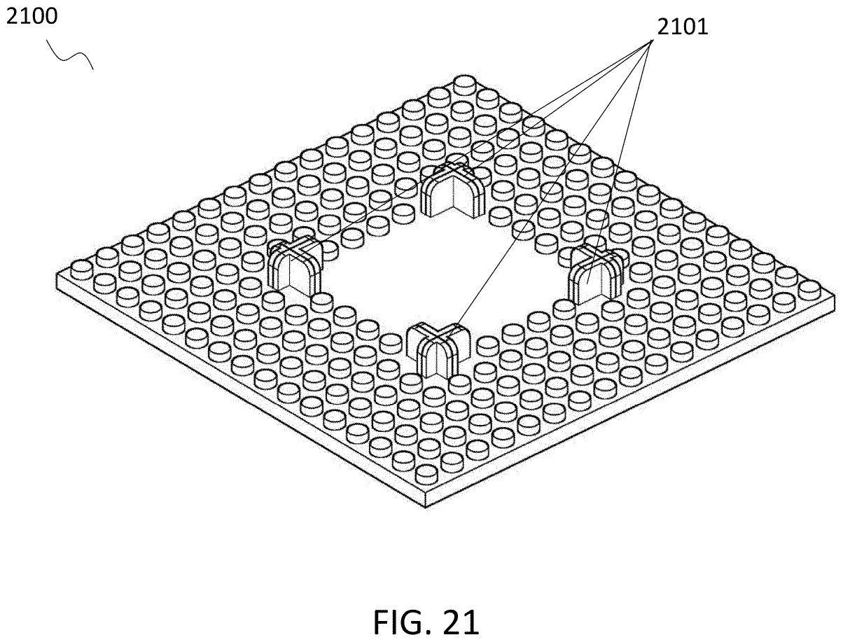

Referring to FIG. 21 a base section 2100 configured to interface with or hold a block, such as the block depicted in FIGS. 20A and 20B, and/or one or more image sections, such that the block and image section can be connected to or comingled with another building set is depicted in accordance with an embodiment. The base section 2100 may include one or more connectors associated with the other building set, such as LEGO studs or recesses. The base section 2100 may include one or more grooved connectors 2101. In some embodiments, the grooved connectors 2101 may be crossed to allow image sections to be placed at different angles. The grooved connectors (2101) in FIG. 21 cross at right angles and run parallel to the sides of the flat rectangular area in the center of the base section 2100. Photo or image sections placed in the grooves (2101) may be held in a vertical positions, parallel to and alongside the surfaces of a compatible cuboid block placed in the flat center of the base section 2100.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 1120f). Claims that do not expressly include the phrase “means for” or “step for” are not to be interpreted under 35 U.S.C. 112(f).

What is claimed is:

1. A toy figure comprising:
one or more predominantly flat first portions, each first portion comprising:
a first layer comprising an image receptive material rendered with a first digital image;
a second layer comprising an adhesive material; and
a third layer attached to the first layer by the second layer;
one or more second portions, each second portion comprising:
at least one connecting groove to engage with at least one of the one or more first portions to hold the at least one of the one or more first portions in a desired position in three-dimensional space relative to the second portion; and
a three-dimensional base part, wherein the three-dimensional base part comprises at least one of: shoes, feet, an animal, part of an animal, a vehicle, or a plant base.

2. The toy figure as recited in claim 1, wherein the third layer comprises the image receptive material rendered with a second digital image.

3. The toy figure as recited in claim 2, wherein the one or more first portions are each formed with a single sheet of the image receptive material that is folded along a fold line to form the first layer and the third layer of the one or more first portions from the single sheet.

4. The toy figure as recited in claim 2, wherein the second digital image is a mirror image of the first digital image.

5. The toy figure as recited in claim 3, wherein one of the first portions forms a one-part flat toy figure.

6. The toy figure as recited in claim 1, wherein the at least one connecting groove comprises a first member and a second member each having an opposing surface for engaging, through friction or tension, at least one of the one or more first portions.

7. The toy figure as recited in claim 1, wherein the at least one connecting groove comprises a mating section to removably engage with the three-dimensional base part.

8. The toy figure as recited in claim 7, wherein the mating section comprises a recess to engage a stud to removably engage the at least one connecting groove to the three-dimensional base part.

9. The toy figure as recited in claim 7, wherein the mating section includes a ferromagnetic element within the at least one connecting groove, to form a connection with a magnet in a separate part.

10. The toy figure as recited in claim 1, wherein the image receptive material includes at least one of: Zink stickers, Zink paper, instant film paper, thermal printer paper, plain paper, sticker paper, vinyl sticker paper, label paper, glossy paper, a laminate covering, and photo paper.

11. The toy figure of claim 1, wherein the digital image includes a digitized photo of a hand drawn illustration and a digital photograph of a face.

12. A method of producing a toy figure comprising:
imprinting a digital image on a top surface of the image receptive material, the image receptive material having adhesive covered by a peelable paper back on a bottom surface
removing the peelable paper back from the bottom surface to expose the adhesive;
manually folding the image receptive material containing the digital image along a fold line that divides the image receptive material into two sections, a first layer and a second layer;
mutually engaging the exposed adhesive on the bottom surface of the first layer and the second layer to form a two-sided first portion; and
pairing the first portion with a second portion comprising:
at least one connecting groove configured to engage with the first portion to hold the first portion in a desired position in three-dimensional space relative to the second portion; and
a three-dimensional base part, wherein the three-dimensional base part comprises at least one of: shoes, feet, an animal, an animal part, a vehicle, or a plant base that is configured to be perceived by a user as a visual extension of the digital image.

13. The method as recited in claim 12, wherein imprinting the digital image on the top surface of the image receptive material includes imprinting the digital image on the image receptive material on one side of the fold line and imprinting a mirror outline image of the digital image on the image receptive material on another side of the fold line such that when the image receptive material is folded along the fold line, the two images align and overlap.

14. The method as recited in claim 12 wherein the connecting groove includes two opposing surfaces configured to receive and engage the first portion between the two opposing surfaces.

15. The method as recited in claim 13 further comprising:
scaling the digital image to a pre-determined size;
creating with a processing device a mirror outline image of the digital image; and
printing the digital image and the mirror outline image on separate sides of the fold line such that the outlines of the two images align and overlap when the adhesive layer is exposed, and the image receptive material is folded along the fold line to form the first portion.

16. The method as recited in claim 15, further comprising:
integrating a recess in the connecting groove configured to interlock via friction with a stud of diameter 4.8 mm; and

17. The method as recited in claim 12 wherein the digital image includes at least one of: a digitized drawing, a digitized illustration, or a digital photograph.

18. The method as recited in claim 12 further comprising:
modifying the digital image based on one or more source digital images; and
storing the digital image in response to the modification.

19. The method as recited in claim 12, wherein imprinting the digital image comprises printing the digital image with a printing device that comprises at least one of: a Zink printer, a Zink sticker printer, an instant camera, a Zink camera, a thermal printer, a laser printer, an ink jet printer, and a dot-matrix printer.

20. A part to hold a toy figure, the part comprising:
a recess on a bottom side configured to interlock with and cover the top of a cylindrical stud of diameter 4.8 mm; and
a thin, flat blade protruding lengthwise from a top side, the blade less than 75 mm long and less than 10 mm wide;
wherein the bottom side of the part has a footprint less than or equal to 9.5 mm long and 9.5 mm wide.

21. The part as recited in claim 20, wherein the thin, flat blade has been adhered between the first and third layers of the toy figure as recited in claim 3

22. The toy figure of claim 1, wherein the digital image includes a digitized photo of a hand drawn illustration or a digital photograph of a face.
